(19) United States
(12) Patent Application Publication
(10) Pub. No.: US 2017/0281471 A1
(43) Pub. Date: Oct. 5, 2017

(54) PILL DISPENSING ASSEMBLY

(71) Applicant: Joseph Bruce Hamilton, Dunn, NC (US)

(72) Inventor: Joseph Bruce Hamilton, Dunn, NC (US)

(73) Assignee: PSCAP, LLC, Dun, NC (US)

(21) Appl. No.: 15/623,752

(22) Filed: Jun. 15, 2017

Related U.S. Application Data
(63) Continuation-in-part of application No. 13/430,239, filed on Mar. 26, 2012, now Pat. No. 9,730,860.
(60) Provisional application No. 61/585,344, filed on Jan. 11, 2012.
(60) Provisional application No. 61/570,384, filed on Dec. 14, 2011.
(60) Provisional application No. 61/564,598, filed on Nov. 29, 2011.
(60) Provisional application No. 61/556,609, filed on Nov. 7, 2011.
(60) Provisional application No. 61/555,341, filed on Nov. 3, 2011.

(51) Int. Cl. A61J 7/00; B65D 50/00; G06F 19/00; B65D 41/04

(52) U.S. Cl. CPC A61J 7/0076; B65D 41/0407; B65D 50/00; G06F 19/3462; A61J 2200/70

(57) ABSTRACT

A drug dispensing assembly for dispensing solid drug delivery vessels from a bottle includes a first layer having a vessel exit passage. A second layer is operatively connected to the first layer, and includes a vessel entry passage horizontally offset from the exit passage. A vessel dispensing layer is positioned between the first and second layers, is movable with respect to the first and second layers, and includes a holding chamber sized to receive the vessel. The holding chamber is movable from a first loading position in which the holding chamber is aligned with the entry passage and is horizontally offset from the exit passage to receive the vessel, to a second dispensing position in which the holding chamber is aligned with the exit passage and is horizontally offset from the entry passage to dispense the vessel through the exit passage. The holding chamber may be configured with a fulcrum and a ramp. Interchangeable alignment inserts and interchangeable chamber inserts may be inserted into slots within the second layer and vessel dispensing layer for receiving interchangeable inserts.

### CROSS REFERENCE TO RELATED APPLICATIONS

This application is a Continuation-in-Part of U.S. application Ser. No. 13/430,239 filed on Mar. 26, 2012 which is a U.S. non-provisional patent application claiming priority to the following U.S. provisional patent applications: Application Ser. No. 61/555,341 filed on Nov. 3, 2011; Application Ser. No. 61/556,609 filed on Nov. 7, 2011; Application Ser. No. 61/564,598 filed on Nov. 29, 2011; Application Ser. No. 61/570,384 filed on Dec. 14, 2011; and Application Ser. No. 61/585,344 filed on Jan. 11, 2012. Each of the aforementioned applications is incorporated in its entirety by reference herein.

### TECHNICAL FIELD

The present invention generally relates to medication dispensing, and particularly relates to a pill dispensing assembly for dispensing pills, tablets, and/or capsules, generically referred to as drug delivery vessel, from a pill bottle,

### BACKGROUND

Prescription drugs abuse has become an increasingly severe societal problem, and has in some instances surpassed abuse of more common street drugs. In particular, abuse of prescription painkillers has been problematic. Several states have already created prescription drug abuse databases to track the frequency with which individuals fill prescriptions for certain prescription medications, and even to track over the counter purchase of medications, such as pseudoephedrine, which are known to be used as ingredients in abused street drugs.

Although pharmacies can track how often prescriptions are filled and control the amount of pills given to a patient with dosing, they cannot ensure that the patient doesn't disregard a dosing schedule and ingest an excess quantity of pills at a given time. Pharmacies also cannot ensure that patients, caretakers or other people with access to patient medication do not divert prescription drugs for abuse or illegal sale.

Particularly in cases where patients have known history of abusing narcotics, it is desirable to prevent those patients from engaging in prescription drug abuse. To date, pharmacies have relied on “childproof” bottle caps and other cap designs to prevent inappropriate access to medication. However, these caps do not control/monitor individual pill dispensing, and therefore do not effectively address any of the issues discussed above.

### SUMMARY

A plurality of pill dispensing assemblies for controlling and/or monitoring the dispensing of pills from a pill container are disclosed. According to one embodiment, a pill dispensing assembly for dispensing a pill from a pill bottle includes a first layer that includes a pill exit passage. A second layer is operatively connected to the first layer, and includes a pill entry passage that is horizontally offset from the exit passage. A pill dispensing layer is positioned between the first and second layers, is movable with respect to the first and second layers, and includes a holding chamber sized to receive the pill. The holding chamber is horizontally movable from a first loading position in which the holding chamber is aligned with the entry passage and is horizontally offset from the exit passage to receive the pill, to a second dispensing position in which the holding chamber is aligned with the exit passage and is horizontally offset from the entry passage to dispense the pill through the exit passage.

In the same or another embodiment, a pill dispensing assembly for dispensing a pill from a pill bottle includes a first layer including a pill exit passage, and a second layer operatively connected to the first layer. The second layer comprising a pill entry passage that is horizontally offset from the exit passage. A pill dispensing layer is positioned between the first and second layers. A longitudinal axis extends through the first layer, second layer, and pill dispensing layer, and the entry and exit passages are radially offset from each other. A holding chamber within the pill dispensing layer is radially movable from a first loading position in which the holding chamber is aligned with the entry passage and is radially offset from the exit passage to receive a pill, to a second dispensing position in which the holding chamber is aligned with the exit passage and is radially offset from the entry passage to dispense the pill through the exit passage. In another embodiment, the pill dispensing layer is linearly movable from a first loading position in which the holding chamber is aligned with the entry passage and is offset from the exit passage to receive a pill to a second dispensing position in which the holding chamber is aligned with the exit passage and is offset from the entry passage to dispense the pill through the exit passage.

According to another exemplary embodiment, a pill dispensing assembly for dispensing a pill from a pill bottle comprises a first layer including a pill exit passage. A pill dispensing layer is axially aligned with and rotatable with respect to the first layer. A first side of the pill dispensing layer faces the first layer, and an opposite second side of the pill dispensing layer faces a pill storage area. The pill dispensing layer includes a holding chamber sized to receive a pill from the storage area, A driveshaft is configured to rotate the pill dispensing layer from a loading position in which the holding chamber is exposed to the storage area to receive the pill from the storage area, to a dispensing position in which the holding chamber is aligned with the exit passage to dispense the pill through the exit passage. A timer is configured to control rotation of the pill dispensing layer between the loading and dispensing position.

According to another exemplary embodiment, a device to control dispensing of a pill from a pill container includes a pill dispensing passage that extends through the device along a first axis and includes an inlet area and an opposing outlet area that are aligned along the first axis. A catch member extends at least partially into the inlet area of the pill dispensing passage from a first side, and is rotatable about a second axis that is transverse to the first axis. A contact member is biased into the inlet area of the pill dispensing passage from an opposing second side. An elongated plunger is spaced away from the passage, and includes a first plurality of teeth sized to engage a second plurality of teeth on the catch member to effect rotation of the catch member about the second axis, such that depression of the plunger in a first direction engages a pill between the catch member and the contact member and advances the pill from the inlet area to the outlet area in an opposite second direction.

In these devices, a controller may be used to record timing information related to pill dispensing, and to restrict dispensing of pills to predefined dosage times. Thus, pill dispensing may be timed or time monitored.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates an exploded view of an example pill dispensing assembly for dispensing pills from a pill bottle.

FIG. 2 illustrates an assembled view of the pill dispensing assembly of FIG. 1.

FIG. 3A illustrates a holding chamber of the assembly of FIG. 1 in a loading position.

FIG. 3B illustrates the holding chamber of the assembly of FIG. 1 in a dispensing position.

FIG. 4 schematically illustrates a controller of the assembly.

FIGS. 5A-B illustrate example embodiments of a first layer of the assembly of FIG. 1.

FIG. 6 illustrates another exemplary pill dispensing assembly.

FIG. 7A illustrates the holding chamber of the assembly of FIG. 6 in a loading position.

FIG. 7B illustrates the holding chamber of the assembly of FIG. 6 in a dispensing position.

FIG. 8 illustrates another exemplary pill dispensing assembly.

FIG. 9A illustrates the holding chamber of the assembly of FIG. 8 in a loading position.

FIG. 9B illustrates the holding chamber of the assembly of FIG. 8 in a dispensing position.

FIG. 10 illustrates another exemplary pill dispensing assembly.

FIG. 11 illustrates an enlarged view of the assembly of FIG. 10.

FIG. 12 illustrates an exemplary childproof cap including locking features.

FIGS. 13A-B illustrate locking members of the configuration of FIG. 12 in a locked position and an unlocked position.

FIG. 14 illustrates an exemplary pill dispensing assembly with interchangeable chamber and alignment inserts.

FIGS. 15A-F illustrates exemplary first layer, pill dispensing layer, and second layer and movement from a pill loading position to a pill dispensing position.

FIGS. 16A-F illustrates another exemplary first layer, pill dispensing layer, and second layer and movement from a pill loading position to a pill dispensing position.

FIG. 17A-B is a bottom up view and a top down view, respectively, illustrating an exemplary pill dispensing assembly.

FIG. 18 is a cross sectional view of the pill dispensing assembly of FIGS. 17-18 in a loading position.

FIG. 19A-B is a cross sectional view of an exemplary first layer and sloping second and pill dispensing layers in a loading position and dispensing position.

### DETAILED DESCRIPTION

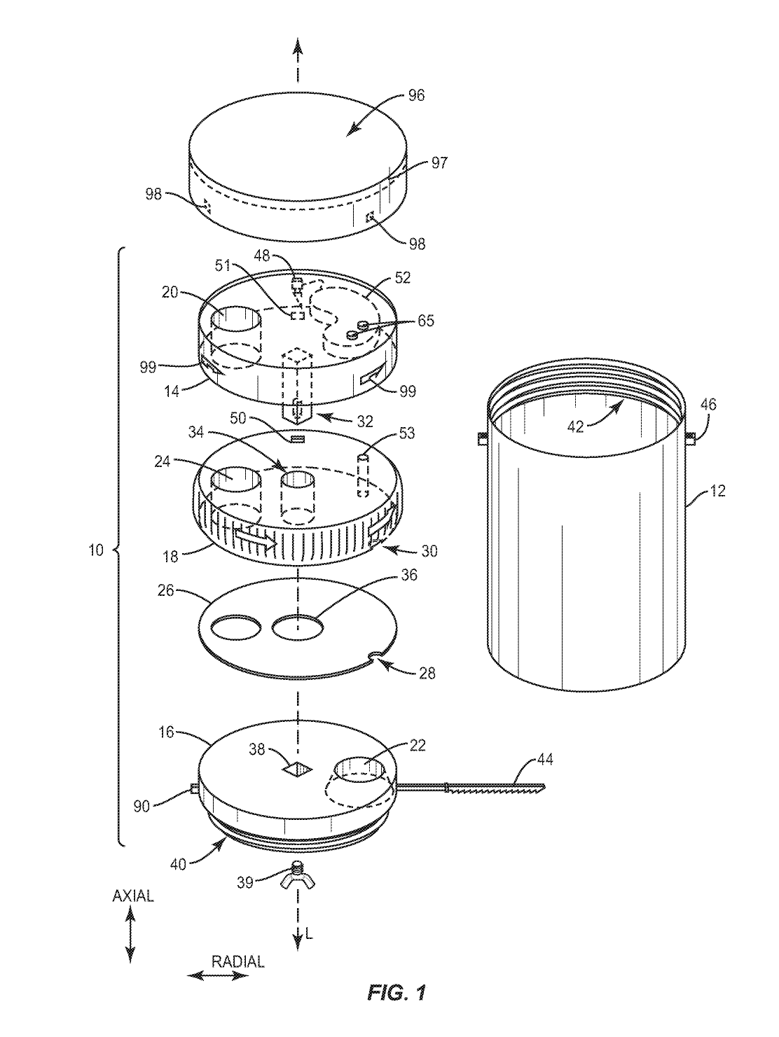

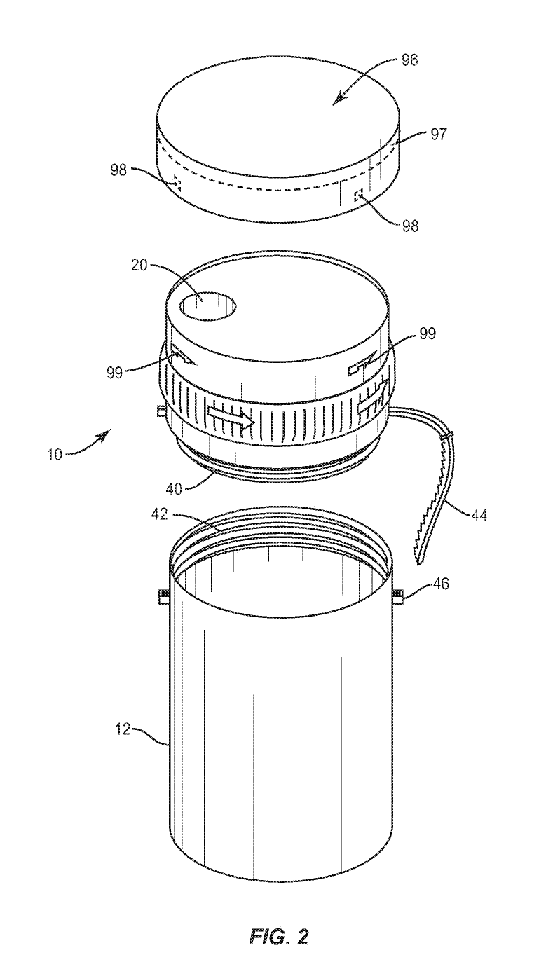

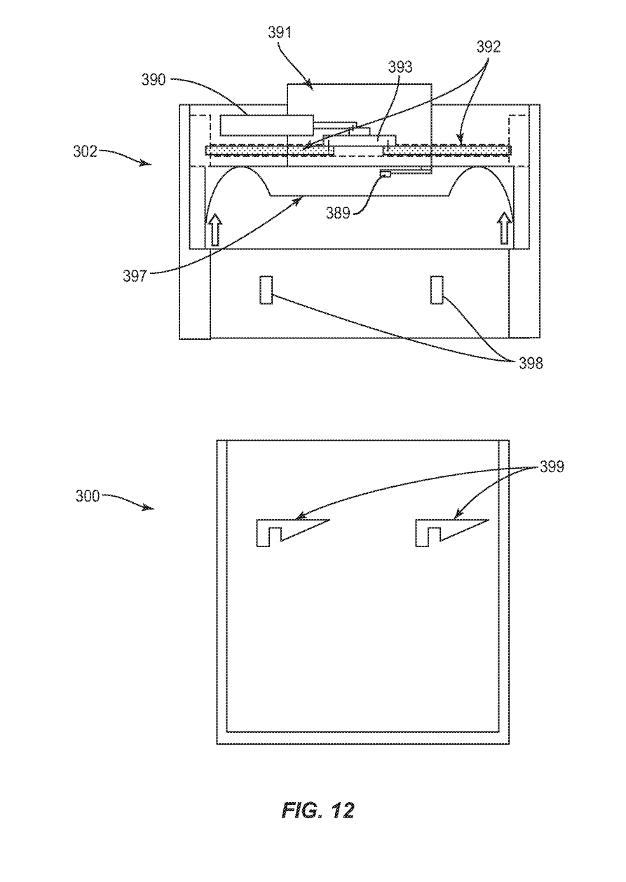

FIG. 1 illustrates an exploded view of a first example pill dispensing assembly 10 for dispensing a pill or “tablet” from a pill bottle 12, and FIG. 2 illustrates a corresponding assembled view of the assembly 10. The pills may include pharmaceutical solid dose, or gelatin capsules, for example. The assembly 10 includes a first layer 14, a second layer 16 and a pill dispensing layer 18. The first layer 14 includes a pill exit passage 20 through which a pill from the pill bottle 12 may exit the pill bottle 12 for patient consumption. The second layer 16 is operatively connected to the first layer 14, and includes a pill entry passage 22 that is horizontally and radially offset from the exit passage 20 with respect to a longitudinal axis L. The longitudinal axis L extends through the layers 14, 16, 18, and the layers 14, 16, 18 are coaxial with respect to the axis L. In one example, the pill entry passage 22 has a frustoconical shape to facilitate the entry of pills into the entry passage 22 with greater ease. Of course, this is only an example, and other pill entry passage 22 profiles could be used. The assembly 10 may be used as a cap for the pill bottle 10. Alternatively, a childproof bottle cap 96 including a flexible sealing diaphragm 97 may be secured to the assembly 10 via childproof lock pins 98 on the cap 96, and corresponding childproof lock members 99 on the first layer 14. The diaphragm 97 may act as a moisture seal. An exemplary diaphragm is illustrated in greater detail in a cross-sectional view of the example childproof cap of in FIG. 12. (see ref. numeral 397).

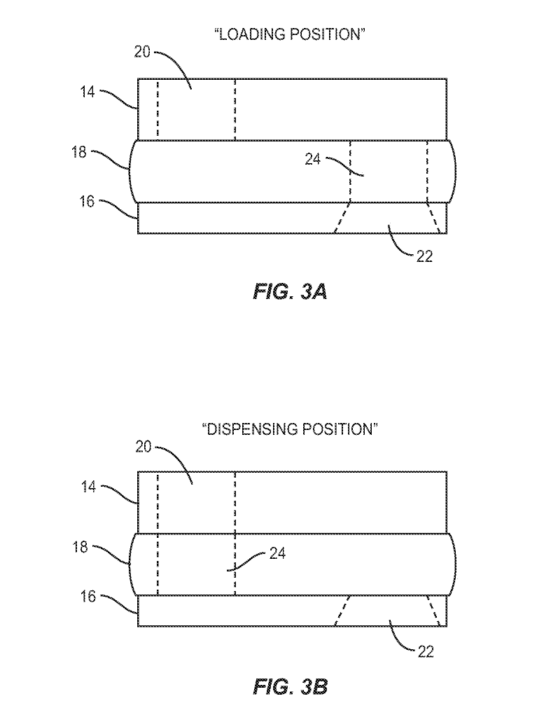

The pill dispensing layer 18 is positioned between the first layer 14 and the second layer 16, and is movable with respect to the first layer 14 and the second layer 16 to dispense a pill. The pill dispensing layer 18 includes a holding chamber 24 sized to receive a pill from the entry passage 22. The holding chamber 24 is horizontally movable from between a loading position (see FIG. 3A) and a dispensing position (see FIG. 3B). In the loading position the holding chamber 24 is aligned with the entry passage 22 and is horizontally and radially offset from the exit passage 22, such that a pill may be received into the holding chamber from the entry passage 22. In the dispensing position, the holding chamber 24 is aligned with the exit passage 20 and is horizontally and radially offset from the entry passage 22, such that the pill may be dispensed via the exit passage 20. In the embodiment of FIGS. 1-3, this movement is achieved by rotation of the dispensing layer 18 about the longitudinal axis L (see, e.g., FIG. 2 which illustrates an example direction of rotation of the pill dispensing layer 18).

While in some embodiments, such as those described above, movement of components between loading and dispensing positions is rotational, in other embodiments, the movement between the loading and dispensing positions is not rotational and is substantially linear. Furthermore, as will be discussed below, movement between the loading and dispensing positions may either be monitored, controlled or both so that pill providers may detect past prescription drug abuse or diversion, and may prevent future abuse.

The assembly 10 as shown in FIGS. 1-3 is designed to allow only a single tablet to be dispensed at a time. That is, the assembly 10 is designed to allow a single pill at a time to be transferred from within the bottle 12 to the mobile holding chamber 24. A user then manipulates the holding chamber by 24 rotating the chamber from the loading position to the dispensing position. To dispense multiple pills, the assembly 10 could be controlled to simply permit multiple transitions between the loading and dispensing positions such that a single pill would be dispensed, but two pills could be dispensed in close succession. Alternatively, the assembly 10 may be designed to dispense multiple pills simultaneously. For example, the assembly 10 may include two holding chambers 24 in the dispensing layer 18, two pill entry passages 22 in the second layer 16, and two exit passages 20 in the first layer 14, such that two pills could be dispensed simultaneously.

Referring again to FIG. 1, a moisture layer 26 is positioned between the dispensing layer 18 and the second layer 16. The moisture layer 26 acts as a seal (e.g. a gasket) to prevent moisture from entering the pill bottle 12 and adversely affecting pills stored in the bottle 12. The moisture layer 26 may include a guiding feature 28 (e.g. a notch) to help align the layer 26 beneath the dispensing layer 18 via a mating guiding feature 30 on the dispensing layer 18.

In the embodiment of FIG. 1, the second layer 16 is rotationally fixed with respect to the first layer 14 via an extension 32. The extension 32 passes through a central opening 34 in the dispensing layer 18 and a central opening 36 in the moisture layer 26, and is secured to an opening 38 in the second layer 16. A fastener 39 may be used to secure the extension within opening 38. As shown in FIG. 1, the extension 32, and the corresponding opening 38 in the second layer 26, have a non-circular profile (e.g. a square profile) such that the extension 32 prevents the first layer 14 from rotating with respect to the second layer 16. The openings 34, 36 may have a different or simply larger profile than that of the extension (e.g. a circular profile) to facilitate rotation of the dispensing layer 18 about the axis L.

The pill dispensing assembly 10 includes at least one fastening mechanism for attaching the assembly 10 to the pill bottle 12. In one exemplary embodiment, the fastening mechanism comprises a circumferential threading portion 40 to mate with corresponding threading portion 42 on the pill bottle 12. In the same or another embodiment, the fastening mechanism may include a zip tie 44 secured to the pill dispensing assembly 10, and sized for one-way insertion through a pill bottle receptor opening 46. The pill bottle 12 may include a plurality of such openings for convenience. A medication dispensing party (e.g. a pharmacy) may require patients to provide their previous pill bottle when providing prescription refills. Thus, if a patient had severed the zip tie 44 to access the contents of the pill bottle, the pharmacist would be able to easily detect such tampering.

As an additional example fastening mechanism, a shrink wrap or tamper proof tape seal may be used to secure the assembly 10 to the bottle 12. One or more studs 90 extending from an exterior of the assembly 10 and/or the pill bottle 12 can secure the shrink wrap or tape to the assembly 10 and the bottle 12 to prevent rotation of the assembly 10 with respect to the bottle 12. The receptors 46 can also serve as studs for securing the shrink wrap or tape. Knowing that a pharmacist would later be able to detect the absence of the shrink wrap or tape may serve to deter pill bottle tampering.

The pill dispensing assembly 10 may also include a solenoid lock 48 operable to extend through an opening 50 in the dispensing layer 18 to selectively prevent the holding chamber 24 from moving between the loading and dispensing positions at non-dosing times. The lock 48 may either reside in or extend through an opening 51 in the first layer. The lock 48 is controlled by a controller 52.

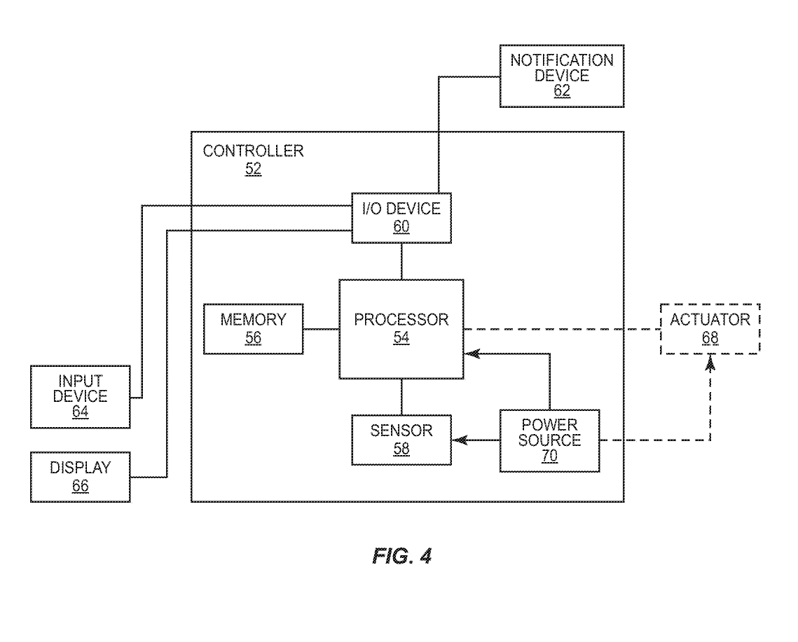

FIG. 4 schematically illustrates an example embodiment of the controller 52. As shown in FIG. 4, the controller 52 incorporates electronic components including a processor 54, memory 56, a sensor 58, and an input/output (I/O) device 60. The processor 54 receives pill detection information from the sensor 58 and records either the raw data, or information related to the raw data. For example, the processor 54 may simply record in memory 56 the time that pills exit the holding chamber 24. As another example, the processor 54 may calculate and record in memory 56 other information relating to pill dispensing, such as a time duration between subsequent pills existing the holding chamber 24 through the exit passage 24.

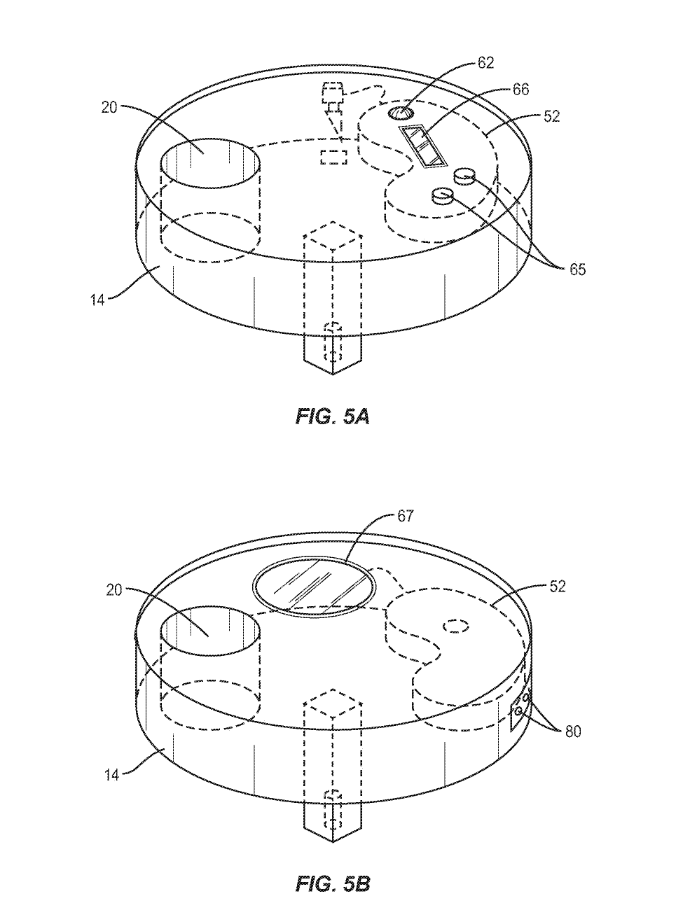

The processor 54 is operatively connected to the I/O device 60, which can serve as an output device to transmit recorded pill timing information and/or other pill dosing information to a remote receiver. Throughout this application, the phrase “pill dosing information” may include one or more of the following: a dosing non-compliance indication, a pharmacy ID, a pharmacist ID, a patient ID, prescribed drug information, etc. For example, the I/O device 60 may include a radio transceiver for transmitting wireless radio frequency (RF) signals to a remote receiver. Alternatively, or in addition to the transceiver, the I/O device 60 may include an output port 80 to which a pharmacist, for example, may connect a data transmission cable to download and/or upload pill timing information, and/or upload pill dosing information (see FIG. 5a). Thus, the I/O device 60 may be utilized by a party such as a pharmacist to determine if a patient is following a prescribed dosing schedule (i.e., is the patient dispensing the appropriate number of tablets per dose and appropriate number of doses per day). The transceiver described above may be part of a passive or active Radio Frequency Identification (RFID) chip, such as a Battery Assisted Passive (BAP) tag, for example. Thus, communication with the I/O device may be performed wirelessly (e.g. RFID) or via a hardwired connection to the output port 80, for example. In one or more embodiments, the processor 54 encrypts the recorded pill timing information and/or the pill dosing information that is stored in memory 56. This encryption may be performed such that only an authorized party, such as a pharmacist, would be able to decrypt the data.

The controller 52 may include software, hardware, or any combination thereof to implement these features, and those described below. The processor 54 may include an Application Specific Integrated Circuit (ASIC), a Field Programmable Gate Array (FPGA), microprocessor/microcontroller, or any other type of processing circuit.

In one embodiment, the sensor 58 is a light-based sensor that is positioned and configured to detect whether or not a pill is present in the mobile holding chamber 24 as a user of the assembly 10 manipulates the holding chamber 24 between the loading and dispensing positions. The light-based sensor may also be positioned such that it can sense the location of the holding chamber 24 as it is moved to the dispensing position. The dispensing layer 18, and optionally the first and second layers 14, 16, may be composed of a clear, transparent plastic (e.g. injection molded plastic, such as polypropylene), and the top layer 14 may be painted to prevent light from being transmitted through the top layer. The light sensor could be calibrated to detect a light change corresponding to a pill within the holding chamber 24, which could then be communicated to the processor 54 to indicate that a pill has been loaded. A passage 53 in the dispensing layer 18 that is aligned with the light sensor in the dispensing position may be used to change an amount of light detected by the light sensor in the dispensing position, which could also be communicated to the processor 54 to indicate pill dispensing. Alternatively, or in addition to the light sensor, a magnet or proximity sensor could be used. Thus, in some embodiments, multiple sensors could be used.

The processor 54 may maintain an internal digital clock with date and time values. This internal clock could be initiated by a manufacturer of the dispensing assembly 10, or by a pill dispensing entity such as a pharmacy. Software executed by the processor 54 could be used to monitor the electronic signal from the sensor 58 to determine whether a pill is present in the holding chamber 24 and when the dispensing layer 18 is aligned such that the holding chamber 24 is closely aligned with the exit passage 20 indicating that a tablet is dispensed. Each of these events would trigger the software to save a value associated with the time and date stamp of the dispense operation into internal memory 56. This process is repeated for each pill dispensed for the bottle 12. The electronic components of the controller 52 would then allow the contents of the memory 56 to be downloaded for review in human readable form or for potential use by other computer systems.

The processor 54 may also be operatively connected to a notification device 62 to provide a patient notification, such as the arrival of a dosage time, or a predefined amount of time passing after a suggested dosing time (see, e.g., FIG. 5A). The notification device 62 may include, for example, a vibrating transducer, a light (e.g. a light emitting diode “LED”), or a sound-emitting device configured to provide a notification at a dosing time.

The processor 54 may also be operatively connected to an additional input device 64 and a display 66. The additional input device 64 may include buttons 65 for example (see FIG. 1), to allow the loader of tablets (e.g. a pharmacy) to store a pill dosing schedule in the memory 56. The controller 52 may utilize the programmed dosage data programmed by the loader above to lock and unlock a mechanical lock mechanism (e.g. solenoid 48), such that movement between the loading and dispensing positions is only permitted at allowed dosing times. To control the lock mechanism, the controller 52 may be operatively connected to an actuator 68. The input device 64 may include a fingerprint sensor 67 in communication with the controller 52. The fingerprint sensor 67 may be used for patient identification (e.g. to record a fingerprint of who is accessing the contents of a pill bottle), and/or may be used in connection with a lock such as the solenoid lock 48, such that the lock would only be disengaged by the controller 52 if an appropriate dosing time had arrived and an acceptable fingerprint was received via the fingerprint sensor 67 (e.g. that of a patient or caregiver). A fingerprint received via sensor 67 may be compared to one or more saved fingerprints stored in memory 56. In one example, the one or more saved fingerprints are not entire fingerprints, but instead include only a few unique attributes of accepted fingerprints, to reduce memory 56 storage requirements. The memory 56 may also store encrypted and/or unencrypted personal information about a patient, including some of the pill dosing information discussed above (e.g. a photo identification number or another personal identifier, pharmacy ID, pharmacist ID, etc). Thus, with or without being used for locking features, the fingerprint sensor 67 could he used simply to identify a patient and record a positive patient confirmation.

A power source 70 (e.g. a battery) may be used to power the processor 54, sensor 58, and actuator 68, and although not shown in FIG. 4 may also be used to power notification device 62, input device 64, and display 66 as needed.

The display 66 may be used to indicate dosing information to either a patient or caregiver (e.g. remaining time until next dose), or to a loader of tablets (e.g. an indicator of tampering or variance from the dosing schedule), For example, the display could display the time remaining until a subsequent dose and/or a time of a last dose. As shown in FIG. 5b, the display 66 may be located on an exterior of the first layer 14. However, this is only an example, and the display 66 could alternatively be located on an exterior of the second layer 16 or the dispensing layer 18. The display 66 may include a liquid crystal display (LCD), for example. Thus, the display 66 may also be used as a notification device as described above.

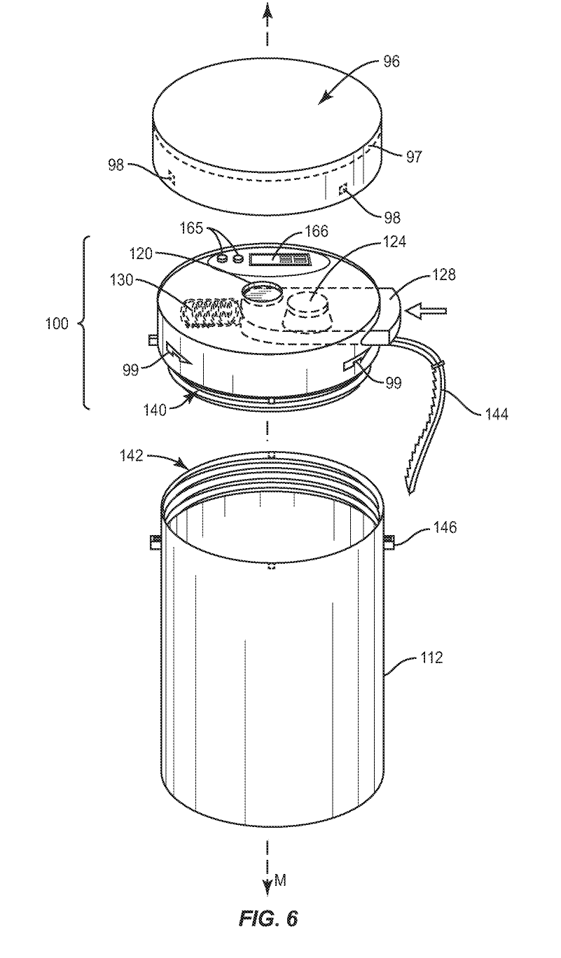

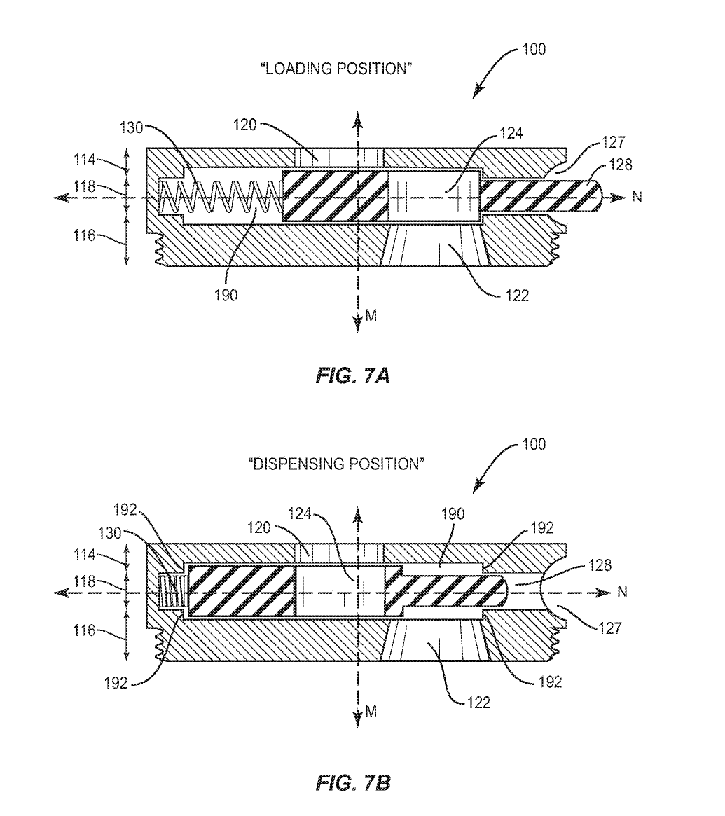

FIG. 6 illustrates an example pill dispensing assembly 100 in which movement of the holding chamber between the loading and dispensing positions is a sliding horizontal movement instead of a rotational movement. The assembly 100 includes a first layer 114, second layer 116 and dispensing layer 118. The first layer 114 includes a pill exit passage 120, and the second layer 116 includes a pill entry passage 122. The pill dispensing assembly 100 extends along a longitudinal first axis M. In this embodiment, the holding chamber 124 is defined by a transport shuttle 128 that is movable within the pill dispensing assembly 100 along a second axis N that is transverse to the first axis M, between a loading position (see FIG. 7A) and a dispensing position (see FIG. 7B). The transport shuttle 128 is biased away from the dispensing position by a bias member 130 (e.g. a coil spring or a leaf spring) within the pill dispensing assembly 100. A range of motion of the transport shuttle may be defined by a stepped portion 192 within a transport shuttle chamber 190. By sliding the transport shuttle 128 along the axis N, a user may transition the assembly 100 from the default loading position to the dispensing position. Movement of the transport shuttle 128 may be performed, for example, by pushing the transport shuttle 128 from the side of the assembly 100 (see FIGS. 7A-B). Of course this is only an example, and it would also be possible to arrange the transport shuttle 128 to be biased towards the dispensing position, such that a pulling of the transport shuttle 128 would be required to load a pill, and then releasing the transport shuttle 128 would return the shuttle to the dispensing position. As shown in FIG. 7, a recess 127 may be formed in the side of the assembly 100 to facilitate user movement of the transport shuttle 128.

As in the embodiment of FIG. 1, the pill exit passage 120 and pill entry passage 122 are horizontally and axially offset from each other with respect to the longitudinal axis M, the pill entry passage 22 may have a frustoconical shape to facilitate the entry of pills into the entry passage 122, and threading portions 140, 142 and/or zip tie 144 with associated receptors 146 may be used to secure the assembly 100 to pill bottle 112. Also, as in the embodiment of FIG. 1, a display 166 may be included, and a lock and sensor may also be included. Optionally, a childproof cap 96 may be used to control access to the assembly 100.

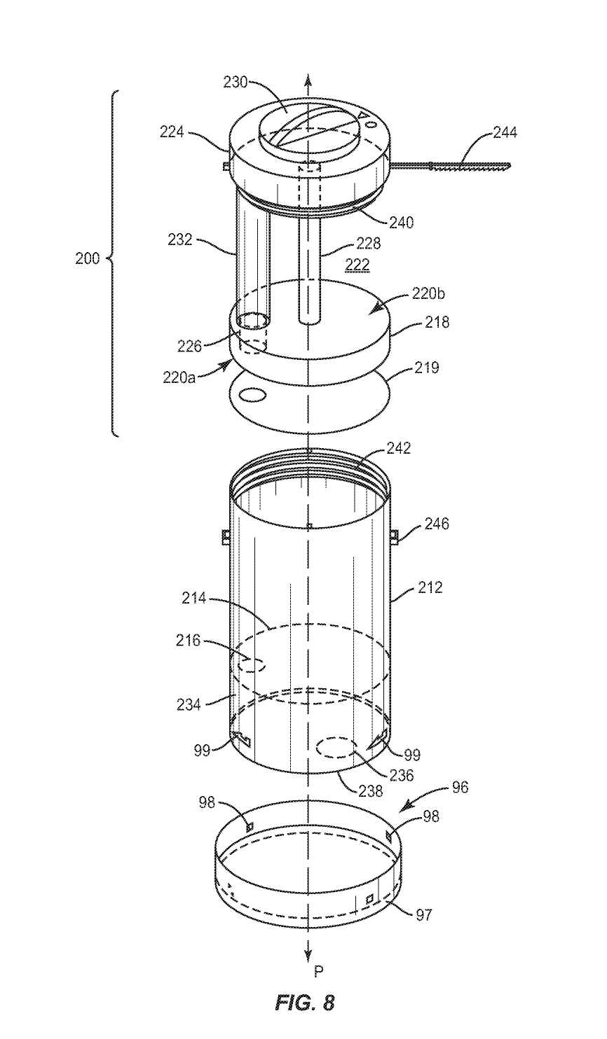

FIG. 8 illustrates another exemplary pill dispensing assembly 200 for dispensing a pill from a pill bottle 212. The assembly 200 extends along a longitudinal axis P. A first layer 214 of the assembly includes a pill exit passage 216. A pill dispensing layer 218 is axially aligned with and rotatable with respect to the first layer 216. A first side 220a of the dispensing layer 218 faces the first layer 214, and an opposite second side 220b of the dispensing layer 218 faces a pill storage area 222. The pill storage area 222 is defined at one end by the second side 220b of the dispensing layer 218, and at a second end by a second layer 224. The pill dispensing layer 218 includes a holding chamber 226 sized to receive a pill from the storage area 222. Optionally, a moisture layer 219 may be situated between the first side 22a and the first layer 214 to prevent moisture from entering the pill storage area 222.

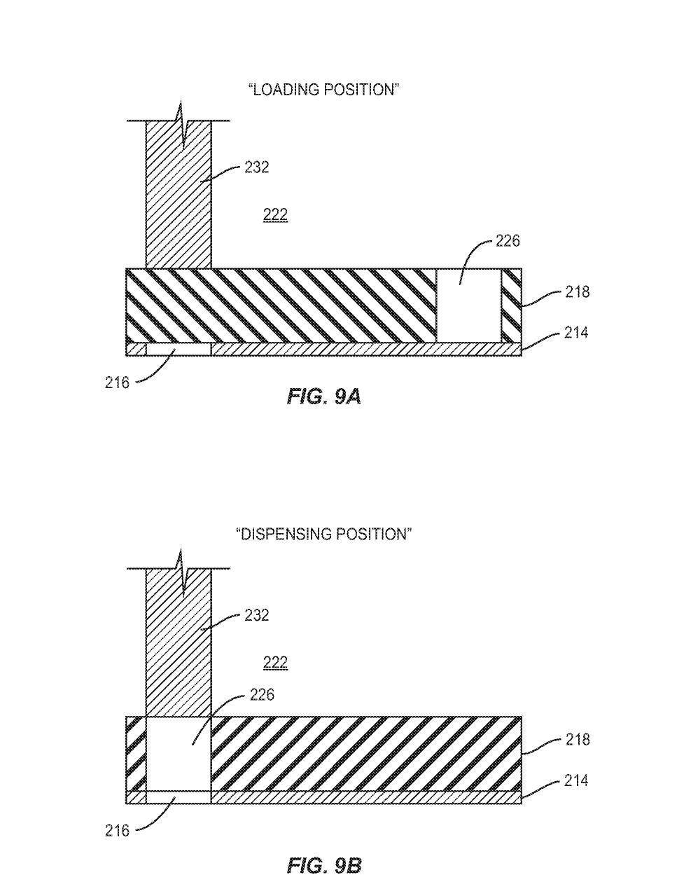

A driveshaft 228 extending from the second layer 224 is configured to rotate the pill dispensing layer 218 from a loading position in which the holding chamber 226 is exposed to the storage area 22 to receive the pill from the storage area 222 (see FIG. 9A), to a dispensing position in which the holding chamber 226 is aligned with the exit passage 216 to dispense the pill through the exit passage (see FIG. 9B). A timer 230 is configured to control rotation of the pill dispensing layer 218 between the loading and dispensing positions. The timer 230 may comprise a digital timer controlling an electric drive actuator to rotate the drive shaft 228, or alternatively may comprise a spring-loaded rotary drive could be used to rotate the drive shaft 228, for example.

A blocking member 232 is aligned with the exit passage 216, and is sized to prevent a pill from entering the holding chamber 226 from the storage area 222 when the pill dispensing layer 218 is in the dispensing position. Once a pill exits through the exit passage 216, the pill enters a dispensing area 234 of the pill bottle 212, from which the pill may pass through a hole 236 in a bottom 238 of the pill bottle 212. Thus, unlike the other embodiments, in which pill dispensing is more easily performed with the bottle inverted, the assembly 200 can be used easily in an upright position.

The timer 230 is configured to control rotation of the pill dispensing layer 218 such that a duration of time of the rotation between the loading and dispensing positions corresponds to a patient dosing schedule. The timer may be configured to only permit rotation of the dispensing layer 218 if the timer dial is turned all the way back to a starting position (see, e.g., circle shape on layer 224). Thus, in the example of FIG. 8 this would be counter-clockwise rotation. The timer 230 would then rotate the driveshaft 228 so that the holding chamber 226 moves from the loading to the dispensing position (see, e.g., the triangle shape on layer 224). As in the embodiment of FIG. 1, and threading portions 240, 242 and/or zip tie 244 with associated receptors 246 may be used to secure the assembly 100 to pill bottle 112. Optionally, a childproof cap 96 may be used to control access to the assembly bottom 238 of the pill bottle 212.

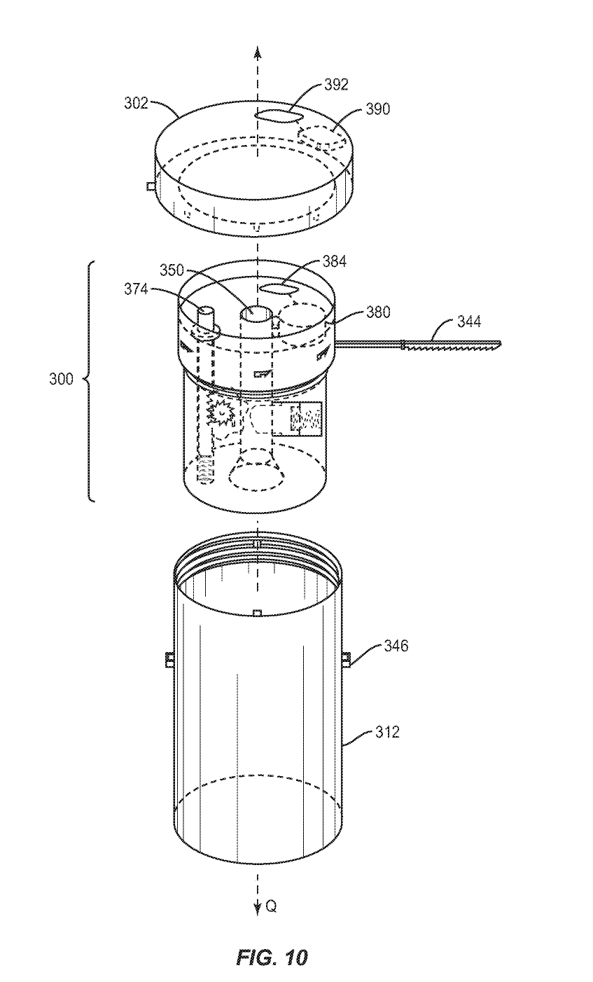

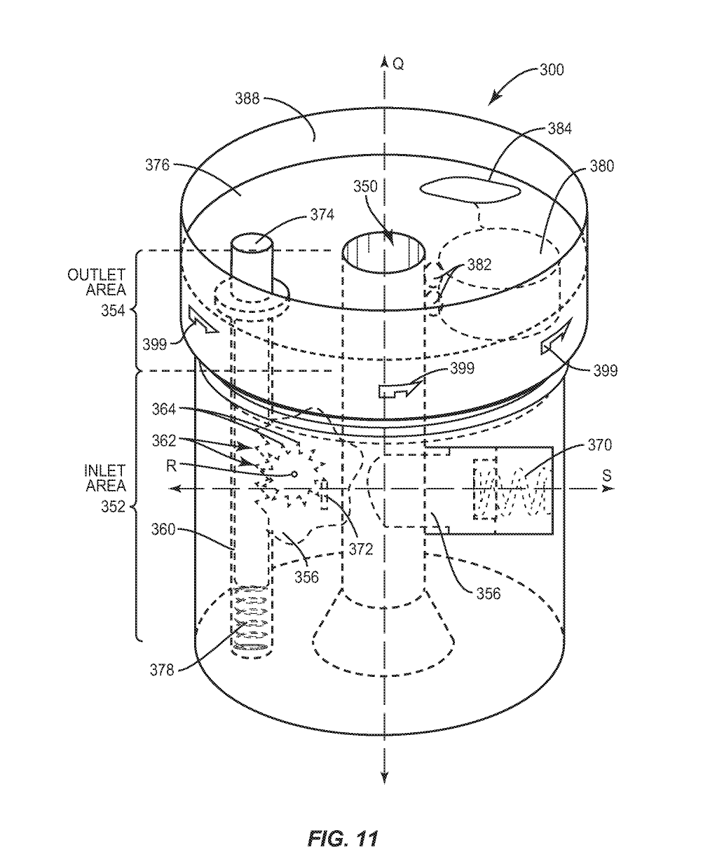

FIGS. 10-11 illustrate yet another exemplary pill dispensing assembly 300. The assembly 300 extends along a longitudinal axis Q, and may be received into pill bottle 312 to dispense pills from the bottle 312. The assembly 300 includes a pill dispensing passage 350 that extends through the assembly along the Q axis and includes an inlet area 352 and an opposing outlet area 354 that are aligned along the axis Q (see FIG. 11). Optionally, a portion of the inlet area 352 may have a frustoconical shape to facilitate the entry of pills into the inlet area 352 with greater ease. A catch member 356 extends at least partially into the inlet area 352 of the pill dispensing passage 350 from a first side. The catch member 356 is rotatable about a second axis R (seen corning out of the page at point R in FIG. 11). The axis R is transverse to the axis Q. A contact member 358 is biased into the inlet area 352 of the pill dispensing passage 350 from an opposing second side of the passage 350.

An elongated plunger 360 is spaced away from the passage 350, and includes a first plurality of teeth 362 sized to engage a second plurality of teeth 364 on the catch member 356 to effect rotation of the catch member 356 about the axis R, such that depression of the plunger 360 in a first direction (downwards along axis Q in FIGS. 10-11) engages a pill between the catch member 366 and the contact member 368, and advances the pill from the inlet area 352 to the outlet area 354 in an opposite second direction (upwards along axis Q in FIGS. 10-11). In effecting this movement, the contact member 358 (which is biased towards the catch member 356 by a bias member 370), is moved along an axis S that is transverse to the axes Q and R. This movement compresses the bias member 370 to move the contact member 358 away from the catch member 356. The axes Q, R and S may be perpendicular to each other. A catch element 372 engages the teeth 364 to only permit rotation of the catch member 356 in a single direction (counter-clockwise in the example of FIGS. 10-11), The plunger 360 may be depressed by pressing a portion 374 of the plunger that extends above a top 376 of the assembly 300. The plunger 360 is biased upwards towards the top 376 of the assembly 376 by a bias member 378.

The assembly 300 may include a controller 380 similar to the controller 52 of FIG. 4. The controller 380 may include a light sensor (see sensing elements 382) operable to sense a pill in the outlet area 354. The controller 380 may use data from the light sensor to record the time that a pill exits the outlet area 354 through a terminal end of the pill dispensing passage 350. Optionally, a fingerprint sensor 384 may be included on the top 376 of the assembly 300, and may be used as in the other embodiments for patient identification. As in the embodiment of FIG. 1, a zip tie 344 with associated receptors 346 on pill bottle 312 may be used to secure the assembly 300 to pill bottle 312.

Referring again to FIG. 11, a cap 302 (optionally a childproof cap similar or identical to the cap 96 of FIG. 1) may be securable to the assembly 300 or the pill bottle 312, to extend over and conceal the outlet area 354 of the pill dispensing passage 350. FIG. 12 illustrates an example childproof cap that may be used in connection with any of the assemblies 100, 200, 300. As shown in FIG. 12, the cap 302 may include a controller 390 (e.g. a solenoid) in operative communication with a fingerprint sensor 391. The controller 390 may be configured actuate a lock to secure the cap 302 to the assembly 300 (or alternatively to bottle 312) via standard childproof lock pins 398 and corresponding childproof lock members 399. This locking prevents access to the outlet area 354 unless an authorized fingerprint is detected by the fingerprint sensor 391, unless a predefined dosing time has arrived, or both.

The controller 390 is operable to move locking members 392 (or “extensions”) to lock or unlock the members 392, and to correspondingly allow or prevent rotation of the bottle cap 302. The locking members 392 may function in a fashion similar to that of a clicking pen, such that power is only required to transition between the locked and unlocked positions, and is not required continuously to maintain the members 392 in either position.

The locking may be triggered when a sensor 389 is contacted by a flexible sealing diaphragm. In addition to serving as a moisture seal, the diaphragm 397 is movable to compress the sensor 389, which notifies the cap 302 that it has been secured to one of the assemblies 100, 200, 300 or a pill bottle. This movement may occur when either the circumference of a pill bottle or a lip on top of one of the assemblies (e.g. lip 388 on top of assembly 300) engages the diaphragm along the arrows of FIG. 12, which causes the diaphragm 397 to flex and contact the sensor 389. Unlocking may then be achieved via a fingerprint sensor, or via a timed release performed by controller 390, for example.

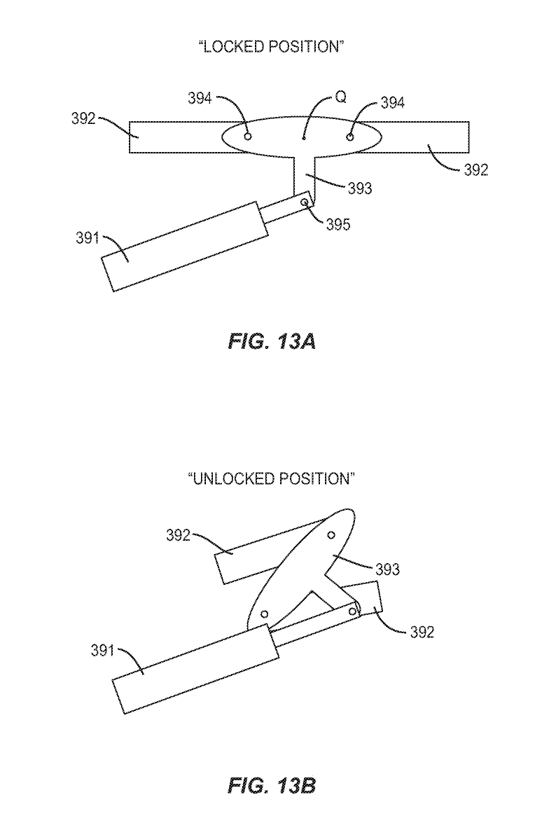

FIGS. 13A-B illustrate the members 392 in a locked position and an unlocked position as viewed with axis Q coming out of the page. A pivot member 393 is secured to the locking members 392 by pivot points 394, and is secured to controller 391 by pivot point 395. By rotating the pivot member 393, the locking members 392 may be either locked or unlocked.

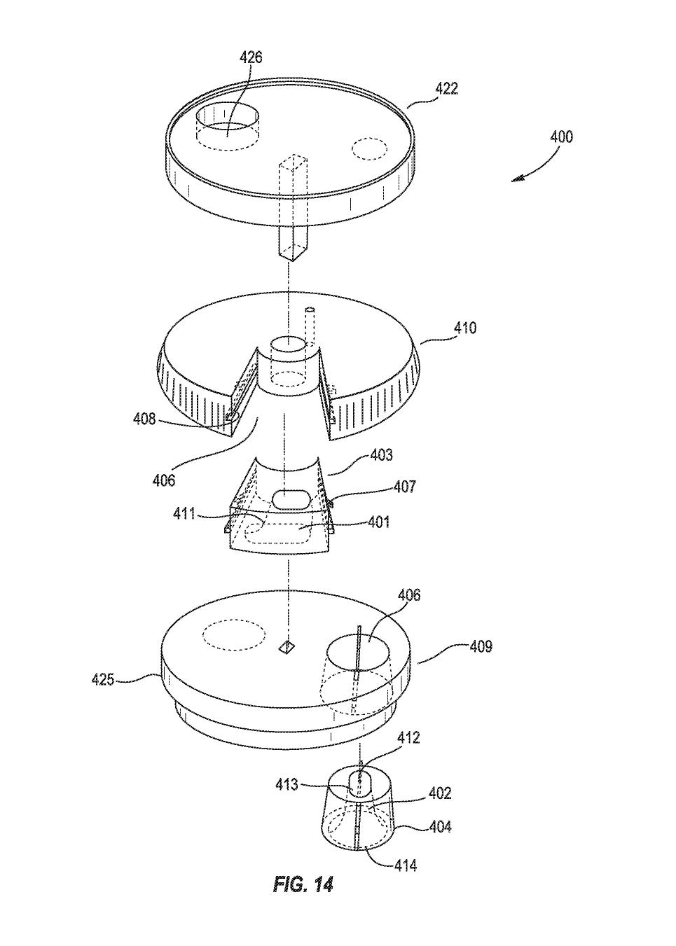

FIGS. 14-16 illustrates yet another embodiment of a partial pill dispensing assembly 400 wherein interchangeable inserts can be used for the holding chamber, pill entry and/or pill exit passages. Said interchangeable inserts can be used to accommodate and facilitate passage of varying sizes and geometries of tablets, capsules, and pills, and to help ensure that one pill is delivered at a time which, in turn, allows for accurate sensing and recordation of time the pill was dispensed. The insert selected by the user will dictate the dimensions and geometries of the holding chamber 401 and/or the pill entry passage 402. It may also ensure proper alignment of the tablet within the entry passage for single tablet entry and passage into the holding chamber 401. Fixed exit/entry passages and holding chambers large enough to hold an oversized tablet might mistakenly allow more than one tablet to be dispensed at a time. Conversely a receiving hole small enough to only allow a smaller tablet to enter the entry passage 402 might not allow a longer tablet to fit into the holding chamber 401. In use, a pharmacist might easily reference a chart, table, or guide and decide which color and number coded insert combination to install prior to filling bottle.

The pill dispensing assembly 400 shown in FIG. 14 comprises a chamber insert 403 and an alignment insert 404. Both inserts can be manually inserted into insert slots 405 and 406 which, in this embodiment, are keyed for proper insert alignment within the slot. The inserts 403 and 404 can snap into position and may be secured by flexible catch tabs 407 within corresponding catch tab slots 408. Flexible catch tabs 407 may be spring biased and retractable and forced to retract inward when pushed into the insert slots and spring outward into the catch tab holes to hold the inserts in place. The inserts used for different components (e.g., pill dispensing layer or second layer) may vary in size, shape and the manner in which they engage the component. For example, in one embodiment, alignment insert 404 is inserted into insert slot 406 of second layer 409 from underneath and, conversely, in the embodiment shown in FIG. 14, chamber insert 403 is inserted into insert slot 405 from the side of the pill dispensing layer 410. In some embodiments, the edges of insert 403 may be rounded to avoid damage to more delicate components of the assembly 400 such as moisture seal.

With reference to FIGS. 14-16, chamber insert 403 may comprise a ramp like member facilitating a reduced profile (thickness or width) of the pill dispensing layer 410 and permitting its width to be shorter than the actual tablet length of an elongated type tablet or capsule. This ramp 411 feature allows long tablets as well and round flat type tablets to be dispensed while minimizing the profiles of the pill dispensing layer 410.

In some embodiments, such as the embodiment shown in FIG. 6, the chamber insert 403 may be installed from the bottom of the pill dispensing layer instead of from the side as shown in FIG. X. For example, the chamber insert 403 may access slot 405 through slot 406 prior to alignment insert 404 installation. in this embodiment, chamber insert 403 must be sufficiently small to pass through slot 406.

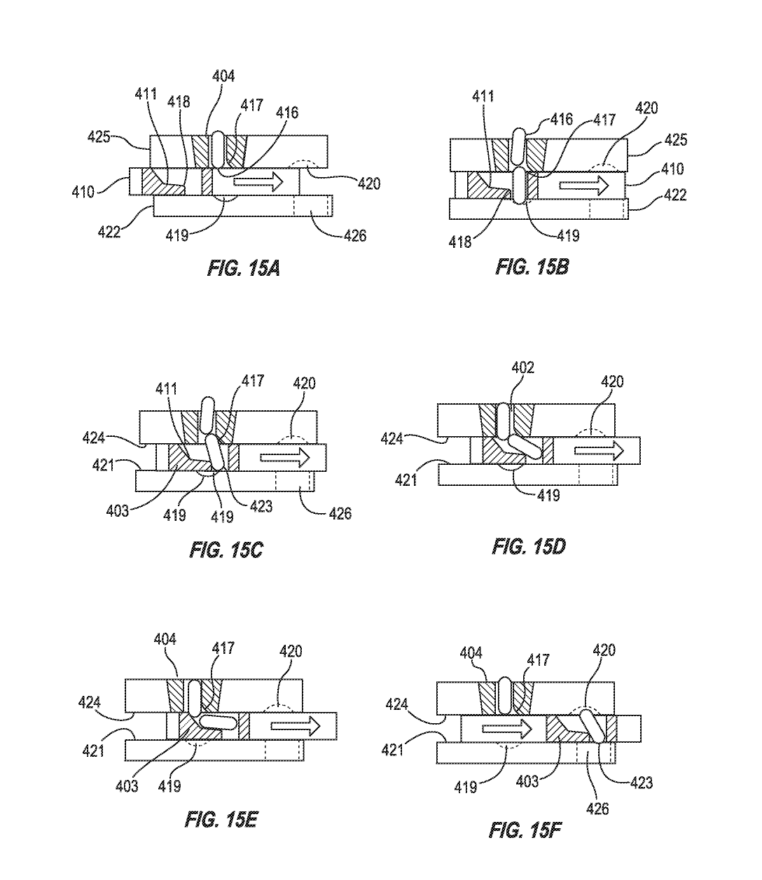

The holding chamber 401 of chamber insert 403 and the entry passage 402 of alignment insert 404 can be configured to facilitate substantially clean and unrestricted tablet transport from the loading position to dispensing position via holding chamber 401. This configuration is designed to decrease binding of tablets in a variety of shapes and sizes while it is delivered to the holding chamber 401 and presented to the exit passage. In the embodiment shown in FIG. 14, holding chamber 401 and entry passage 412 are elongated along the axis of rotation or direction of holding chamber motion. In another embodiment, to promote proper presentation and orientation of the tablet, entry passage 402 of alignment insert 404 progressively narrows along the passage with its smallest aperture 413 closest to the pill dispensing layer 410 and largest aperture 414 nearest the bottle 415 (not shown in this FIG.) For reasons which will become more apparent below, preferably, a tablet enters the holding chamber 401 on its substantially fiat edge 416 or narrow side (shown in FIG. 15) whereby the edge is aligned with the travel path of the holding chamber 401 be it linear or arc shaped.

In another embodiment, one or both sides of the entry passage 402 of alignment insert 404. For example, as depicted in FIG. 15, alignment insert 404 may contain a chamfered surface 417 which also promotes non-binding of longer tablets as the tablet is tilted by the advancement of the pill dispensing layer 410 and holding chamber 401. In one embodiment, the chamfered surface 417 (shown best in FIG. 15) is on the side of the entry passage 402 closest to the direction of travel of the pill dispensing layer 410 and holding chamber 401.

It should be noted that the same geometric and alignment features of the chamber insert and alignment insert apply to the radial design, whereby the pill dispensing layer pivots about a central longitudinal axis passing through the center point of said pill dispensing layer (as illustrated in FIG. 14), as well as the linear transport shuttle design as depicted in FIGS. 6, 15-16. The geometry of the alignment insert entry passage 402 may take on a multitude of complex geometries; however, all are preferably funneled and progressively narrow and elongate toward the end closest the pill dispensing layer such that when the bottle is inverted the tablet is guided to fall into the chamber insert holding chamber 401 on end standing on edge) with the long axis of the tablet in alignment with the radial or linear travel pattern of the pill dispensing layer 410 and holding chamber 401.

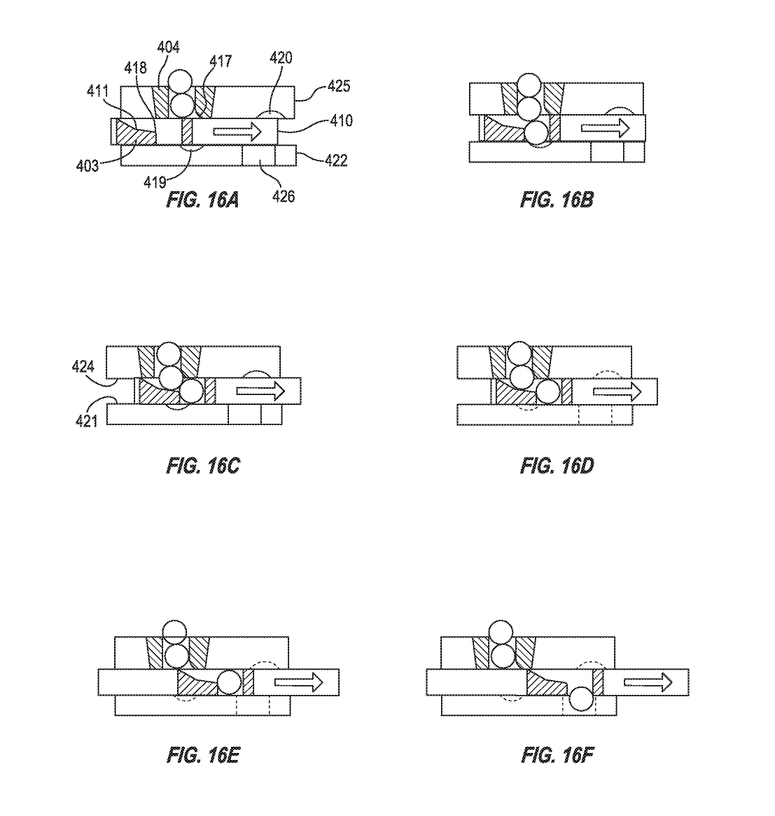

In some embodiments, chamber insert 403 can comprise a ramp 411 and fulcrum 418 which facilitate proper tablet orientation once the tablet has dropped into the chamber insert 403 as shown in FIGS. 14-16. As pill dispensing layer 410 and thereby also holding chamber 401 as defined by chamber insert 403 begins to travel from loading position to dispensing position, fulcrum 418 contacts tablet applying a force that tilts longer tablets backward such that it contacts ramp 411. Said ramp 411 and fulcrum 418 can, in some embodiments, work in concert with the chamfered surface 417 such that as the fulcrum 418 applies force to the tablet, chamfered surface 417 provides sufficient room to allow the tablet to tilt and clear the pill entry passage 402 of alignment insert 404 without binding. In another embodiment, one or more depressions, such as the first depression 419 and second depression 420 shown in FIGS. 15-16, can be added to further assist in proper orientation of the tablet and substantially non-occluded transport of the tablet from loading position to dispensing position. Said depressions can work cooperatively with the ramp and fulcrum features. In the embodiment shown in FIG. 15, first depression is substantially rounded for tablet conformity and is positioned in the lower surface 421 of first layer 422. As pill entry passage 402 and holding chamber 401 are aligned, pill entry passage also aligns with first depression 419. Thus, when a substantially rounded or elongated tablet drops and enters the holding chamber 401 as defined by the chamber insert 403, it comes to rest in first depression 419.

In the case of oblong/longer tablets or capsules, as pill dispensing layer 410 is advanced the upper end of the oblong tablet contacts the ramp 411 and fulcrum 418. Further progression of the pill dispensing layer 410 causes the elongated tablet to pivot on the fulcrum 418 causing upper end 423 of the tablet to lift from the first depression 419 and tilt sideways. The slight curvature of the chamfered surface 417 of the alignment insert 404 allows the elongated table to pivot without binding. This pivot action makes it possible for an elongated tablet which exceeds the height of the holding chamber 401 to fit within the chamber 401 in an inclined orientation. First depression's 419 depth decreases and assists in lifting the elongated tablet as the pill dispensing layer advances.

With reference to FIG. 16, in the case of substantially rounded and substantially flat tablets, the ramp, fulcrum and depression structures may temporarily permit partial entry of second tablet into the holding chamber 401; however, as the pill dispensing layer 410 is advanced, the lower tablet will be forced out of the first depression pushing both tablets upward such that the top tablet will be forced back into the pill entry passage 402. It should be noted that the components within the inserts described above, particularly those described for the chamber insert, may be built in or integral to the pill dispensing layer and holding chamber and not separable, interchangeable inserts.

As mentioned above, a second depression 420 can be added to the upper surface 424 of second layer 425 which substantially aligns with pill exit passage 426 in first layer 422. As the tablet is advance within pill dispensing layer 410 toward dispensing position, upon alignment of holding chamber exit with pill exit passage 426, the tablet may come into contact with one side of pill exit passage 426 forcing tablet upward into a more upright position through action of fulcrum 418 and pill exit passage contact. As tablet becomes more upright, bottom end of tablet may engage second depression 420 allowing sufficient space for the tablet to stand substantially upright, thus promoting passage of the tablet through pill exit passage 426.

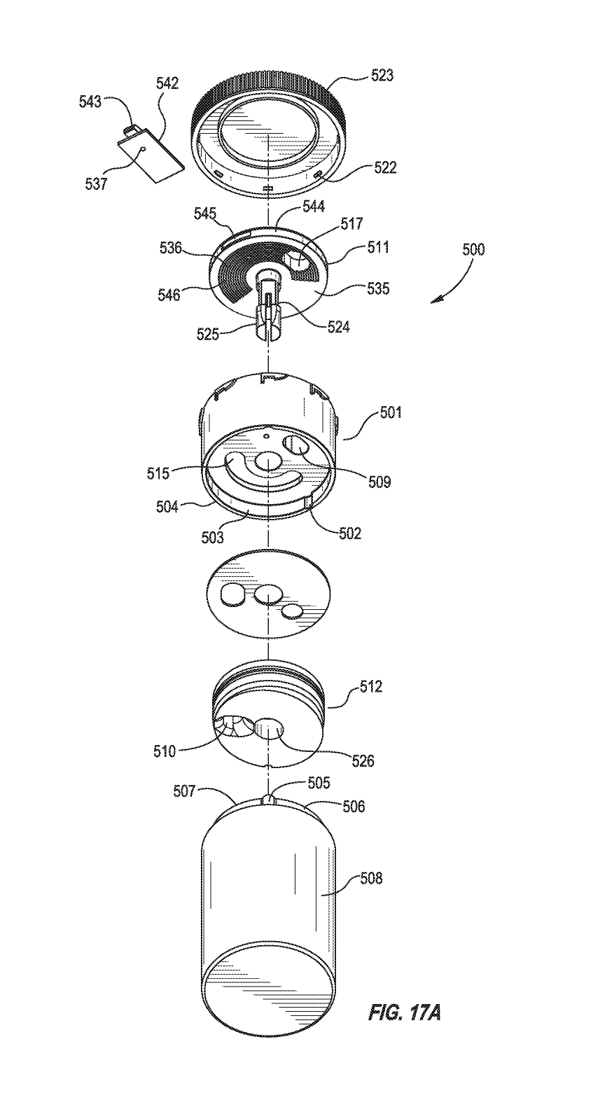

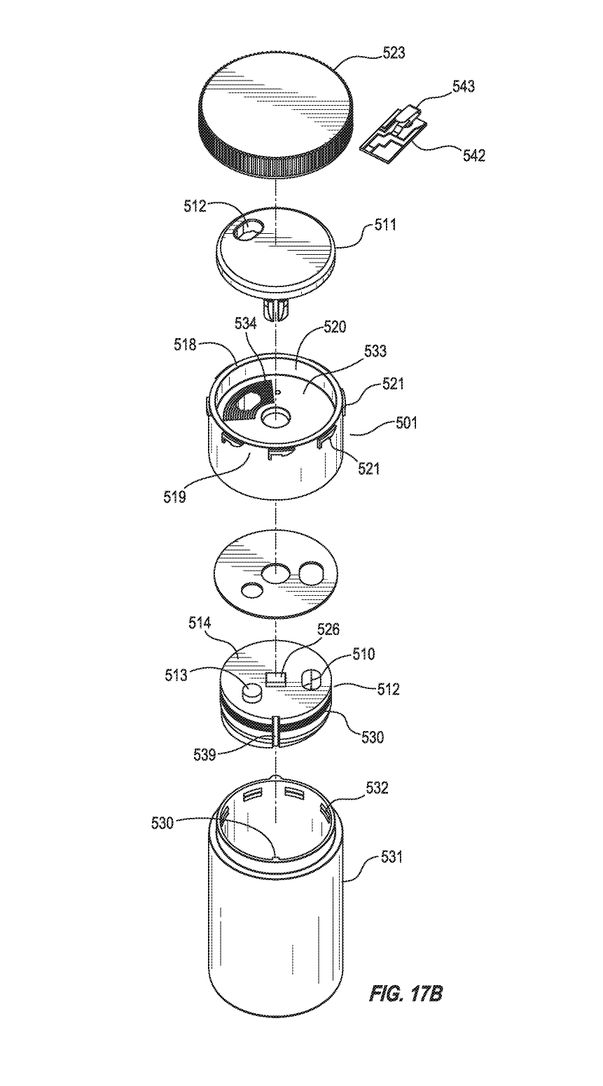

FIG. 17 illustrates a variation of the pill dispensing assembly generally described above but comprising additional unique features. For example, the pill dispensing assembly 500 illustrated in FIG. 17, comprises a dispensing layer 501 that includes a groove 502 positioned on an inside surface 503 of a first rim 504 which mechanically communicates with a rib or protrusion 505 positioned on an outside surface 506 of second rim 507 on pill bottle 508. In this embodiment, the mechanical interaction between rib 505 and groove 502 is designed to bias alignment between holding chamber 509 and entry passage 510. In alternative embodiments, groove 502 can be positioned on first layer 511 or second layer 512.

Rotation of the pill dispensing layer 501 between loading and dispensing positions can be controlled or restricted utilizing various components illustrated in FIG. 17A-B. For example, as shown in FIG. 17B, a cylindrical stop 513 can be positioned on upper surface 514 of second layer 512 and an arcuate slot 515 can be positioned on lower surface 516 of dispensing layer 501. Stop 513 and slot 515 mechanically communicate such that when stop 513 is positioned at slot terminus A, holding chamber 509 is aligned with pill entry passage 510 and when stop 513 is positioned at slot terminus B, holding chamber is aligned with pill exit passage 517. In one embodiment, the mechanical interaction of cylindrical stop 513 with arcuate slot 515 coincides and works synergistically with the interaction between groove 502 and rib 505 to promote proper alignment of holding chamber 509 with either the pill entry passage 510 or pill exit passage 517.

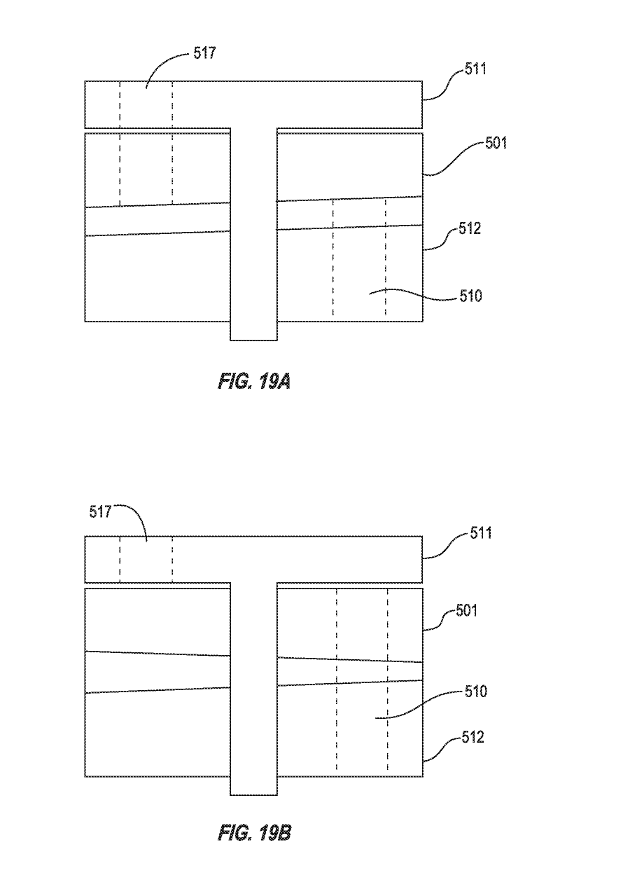

With reference to FIG. 19, in yet another embodiment, dispensing layer 501 can have a sloping surface that communicates with a complimentary sloping surface on either first 511 or second layer 512. Contact between sloping surfaces increases tension progressively between the two surfaces as the layers are rotated with respect to one another producing biased alignment between holding chamber 509 and either pill entry passage 510 or pill exit passage 517. In the embodiment shown in FIG. 19, the lower surface 516 of dispensing layer 501 and the upper surface 514 of second layer 512 are sloped in such a manner. In one embodiment, moisture layer (described in more detail below) may have compressible properties to facilitate such design changes.

With continued reference to the embodiment depicted in FIG. 17, dispensing layer 501 can contain an upper lip or rim 518 that may extend vertically above the top surface of first layer 511 with outer 519 and inner 520 surfaces. In this embodiment, the outer surface 519 of upper lip 518 contains securing elements 521 (generally) positioned substantially equidistant from one another around the perimeter of upper lip 518. These securing elements 521 are designed to interlock with complimentary features 522 (generally) in the cap 523 to secure cap 523 the pill bottle assembly and prevent children from accessing harmful medications. For example, in one embodiment the child proof cap 523 and upper lip 518 of holding chamber 509 are equipped with integral snap-fit features to accomplish this purpose.

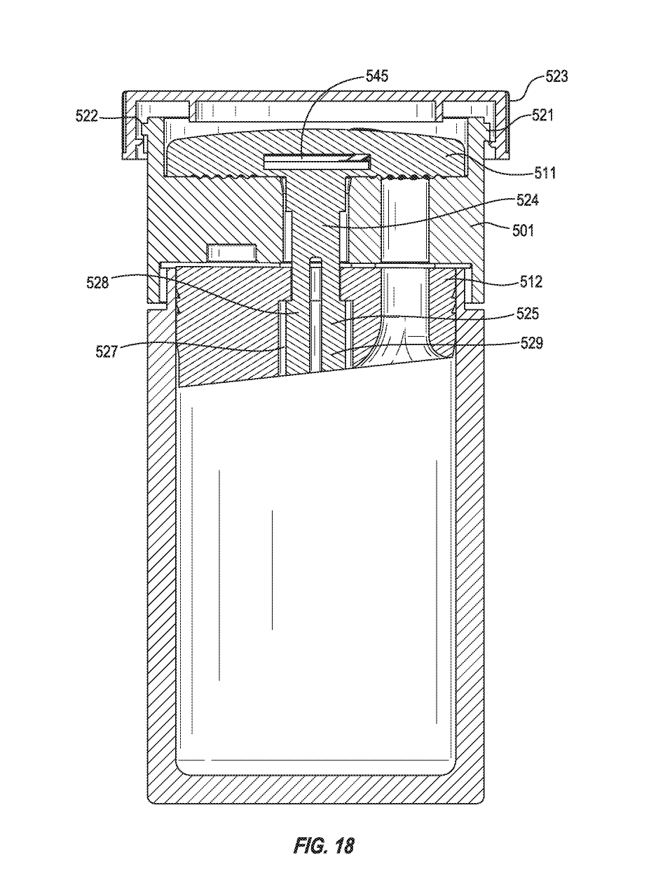

Continuing with the embodiment in FIG. 17-18, extension 524 can have a flexible head 525 at its end that engages opening 526 in the second layer 512. For example, in one embodiment, flexible head 525 engages a socket 527 formed within opening 526. As shown in FIG. 18, flexible head 525 can be two pronged with a gap between each prong 528 and 529 to promote flexibility and socket 527 can be sized to receive a fully expanded flexible head 525 in its resting state. As extension 524 is forced inside second layer 512 opening 526, the prongs 528 and 529 of flexible head 525 are pressed together to reduce its profile as it passes through the opening 526. Once it completely passes through opening 526 and into socket 527, flexible head 525 expands thereby locking extension 524 to second layer 512.

In another embodiment illustrated in FIG. 17, one or more surfaces of second layer 512 may be configured with securing elements that mechanically interact with complementary securing elements positioned on bottle. For example, as shown in FIG. 17A, second layer 512 may contain a first set of snap protrusions 530 and the bottle 531 contains a second set of snap protrusions 532 or alternatively grooves. In this embodiment, a torsional snap fit is created between the second layer and the bottle wherein the protrusions interlock with one another and secure the second layer 512 (and connected components) to the pill bottle 531. It will be recognized that a variety of structures may be used to secure the second layer to the bottle including additional snap fit designs, such as cantilever and annular designs. It should be noted that the layers fit together in such a manner as to apply a moderate amount of pressure to a moisture seal diaphragm or moisture layer, should one be used. In some embodiments, a small portion of the underside of moisture layer contacts the top rim of the bottle to seal any gaps left between the engagement between second layer and bottle.

In the embodiment illustrated in FIG. 17A-B, upper surface 533 of pill dispensing layer 501 contains a first interlocking groove set 534 and bottom surface 535 of first layer 511 contains a second interlocking groove set 536. In this embodiment, and as described in more detail below, a sensor 537 may be positioned at or near the interlocking interface or joint between first layer 511 and pill dispensing layer 501 the general area covered by the grooves. In this manner, the joint forms a substantially impenetrable barrier to tampering, for example, by a foreign object inserted into the assembly to block the sensor. It should be recognized that the first interlocking groove set 534 may be positioned on bottom surface of pill dispensing layer 501 and second interlocking groove set 536 may be positioned on upper surface of second layer 512. In some embodiments, first and second interlocking groove sets 534 may be configured in such a manner to allow pill dispensing layer to move from loading to dispensing position and vice versa while maintaining the substantially impenetrable and tamper resistant joint.

In one embodiment, first layer, pill dispensing layer, moisture seal layer, second layer, and all electronics are assembled as a unit and then second layer is pushed onto the bottle and snapped into place with bottle catches mating with bottle catch grooves as described above. In the embodiment shown in FIG. 17, these components can be oriented by alignment of a bottle pin 539 with the bottle pin groove 540 such that the bottle, second layer, and first layer are fixed with respect to vertical axis.

In the embodiment illustrated in FIG. 17, an electronic assembly may be provided with the pill dispensing assembly. The electronic assembly in FIG. 17B is contained on a board 542 which may comprise a sensor 537, a power source (e.g. battery) and a battery pull tab insulator 543 which can be pulled out after prescription is filled completing the battery circuit and powering up the electronics and program. In the embodiment shown in FIG 17A, side surface 544 of first layer 511 is configured with a slot 545 for board 542 insertion wherein board 542 securely rests within cavity (not shown) inside first layer 511. Bottom surface of first layer 511 may be configured with an sensor window 546 facilitating sensor 543 operations as described in more detail above.

Thus, the various embodiments of pill dispensing assemblies provide a number of benefits. One such benefit is providing he ability to control the dispensing of medication to users, Another benefit is to record pill dispensing data to provide pill providers (e.g. pharmacies and/or doctors) with information indicating whether patients adhere to prescribed dosing schedules, if this information is shared between pill providers (e.g. shared between pharmacies), then patients could be prevented from engaging in Medicare fraud by repeatedly filling the same prescription at multiple pharmacies. The various thumbprint sensors can also be used to prevent fraud by performing identity checks using stored fingerprints, to ensure that those filling or picking up prescriptions are not misrepresenting themselves.

Thus, the foregoing description and the accompanying drawings represent non-limiting examples of the methods and apparatus taught herein. As such, the present invention is not limited by the foregoing description and accompanying drawings. instead, the present invention is limited only by the following claims and their legal equivalents.

What is claimed is:

1. A drug dispensing assembly for dispensing a solid drug delivery vessel from a bottle, comprising:
an alignment insert and a chamber insert;
a first layer comprising a vessel exit passage;
a second layer operatively connected to the first layer comprising a slot for receiving the alignment insert, wherein said alignment insert defines a vessel entry passage that is horizontally offset from the vessel exit passage;
a vessel dispensing layer positioned between the first and second layers and movable with respect to the first and second layers;
wherein said vessel dispensing layer comprises a slot for receiving the chamber insert and wherein said chamber insert defines a holding chamber sized to receive the vessel; and
wherein said holding chamber is movable from first loading position in which the holding chamber is aligned with the entry passage and is offset from the exit passage to receive the vessel, to a second dispensing position in which the holding chamber is aligned with the exit passage and is offset from the entry passage to dispense the vessel through the exit passage.

2. The drug dispensing assembly of claim 1, wherein the slots comprise grooves keyed for proper alignment of the corresponding insert with the slots.

3. The drug dispensing assembly of claim 2, wherein the alignment insert and the chamber insert comprise flexible catch tabs that engage the keyed grooves within the corresponding slots.

4. The drug dispensing assembly of claim 3, wherein said flexible catch tabs are spring loaded.

5. The drug dispensing assembly of claim 3, wherein the grooves further comprise catch tab receptacles for engaging catch tabs for securing inserts within corresponding slots.

6. The drug dispensing assembly of claim 1, wherein the holding chamber and entry passage are elongated along the travel path of the vessel dispensing layer.

7. The drug dispensing assembly of claim 1, wherein the entry passage comprises a first aperture for receiving the vessel from the bottle and a second aperture for delivering the vessel to the holding chamber and wherein said first aperture is larger than said second aperture forming a progressively narrowing passage.

8. The drug dispensing assembly of claim 1, wherein the holding chamber comprises a ramp and a fulcrum.

9. The drug dispensing assembly of claim 1, wherein said alignment insert comprises a chamfered surface.

10. The drug dispensing assembly of claim 1, wherein said first layer comprises a lower surface and wherein said lower surface comprises a depression that receives the vessel as it advances into the holding chamber and is in alignment with the vessel entry passage.

11. The drug dispensing assembly of claim 1, wherein said second layer comprises an upper surface and wherein said upper surface comprises a depression that is in alignment with the vessel exit passage.

12. A drug dispensing assembly for dispensing a solid drug delivery vessel from a bottle, comprising:
a first layer comprising a vessel exit passage;
a second layer operatively connected to the first layer comprising a vessel entry passage that is horizontally offset from the vessel exit passage;
a vessel dispensing layer positioned between the first and second layers and movable with respect to the first and second layers;
wherein said vessel dispensing layer comprises a holding chamber sized to receive a single vessel;
wherein said holding chamber is movable from first loading position in which the holding chamber is aligned with the entry passage and is offset from the exit passage to receive the vessel, to a second dispensing position in which the holding chamber is aligned with the exit passage and is offset from the entry passage to dispense the vessel through the exit passage; and
wherein said holding chamber comprises a fulcrum and a ramp for proper orientation of the vessel and unencumbered transport of the vessel from entry passage to exit passage.

13. The drug dispensing assembly of claim 12 wherein the holding chamber is a separable component from the vessel dispensing layer and is defined by an interchangeable chamber insert.

14. The drug dispensing assembly of claim 12 wherein the pill entry passage is a separable component from the second layer and is defined by an interchangeable alignment insert.

15. The drug dispensing assembly of claim 13 wherein the vessel dispensing layer comprises a slot for receipt of the interchangeable chamber insert.

16. The drug dispensing assembly of claim 14 wherein said second layer comprises a slot for receipt of the interchangeable alignment insert.

17. A drug dispensing assembly for dispensing a solid drug delivery vessel from a bottle, comprising:
a bottle comprising a cylindrical cavity;
a first layer comprising a top surface; a bottom surface, and a side surface, and a vessel exit passage and wherein said bottom surface is configured with a first interlocking groove set;
a second layer operatively connected to the first layer comprising a top surface, a bottom surface, and a vessel entry passage that is offset from the vessel exit passage;
a vessel dispensing layer positioned between the first and second layers and movable with respect to the first and second layers comprising top surface and a bottom surface and wherein said top surface is configured with a second interlocking groove set;
wherein said vessel dispensing layer comprises a holding chamber sized to receive the vessel, the holding chamber being movable from first loading position in which the holding chamber is aligned with the entry passage and is offset from the exit passage to receive the vessel, to a second dispensing position in which the holding chamber is aligned with the exit passage and is offset from the entry passage to dispense the vessel through the exit passage; and
wherein said first interlocking groove set and said second interlocking groove set combines to form a substantially impenetrable joint between said first layer and said vessel dispensing layer.

18. The drug dispensing assembly of claim 17 wherein said second layer comprises a cylindrical stop and said dispensing layer comprises a double ended arcuate slot configured with at least one terminus, and wherein said cylindrical stop and arcuate slot mechanically communicate whereby said dispensing layer is prevented from further rotation upon lateral contact between the stop and the terminus.

19. The drug dispensing assembly of claim 17 wherein the bottom surface of the vessel dispensing layer is configured with a third interlocking groove set and the top surface of the second layer is configured with a fourth interlocking groove set and wherein the third interlocking groove and fourth interlocking groove combine to form a substantially impenetrable joint between the second layer and the vessel dispensing layer.

20. The drug dispensing assembly of claim 17 wherein the vessel dispensing layer and the second layer further comprise counter sloped tension surfaces.

21. The drug dispensing assembly of claim 17 further comprising:
a cap comprising a first set of child proof securing elements;
wherein the vessel dispensing layer is configured with an upper rim with outer and inner surfaces and a second set of child proof securing elements positioned about the outer surface of the upper rim; and
wherein the first set and second set of security elements are complementary and mechanically interact to secure the cap to the assembly.

22. The drug dispensing assembly of claim 17 further comprising a mother board, wherein said mother board comprises an integral sensor.

23. The drug dispensing assembly of claim 22 wherein the side surface of first layer comprises a slot for receipt of the mother board.

24. A pill dispensing assembly for dispensing a pill from a pill bottle, comprising:
a first layer including a pill exit passage through which said pill becomes accessible to the user;
a second layer fixed to the first layer, including a pill entry passage that is horizontally offset from the exit passage, wherein said entire second layer and entire first layer are fixed in position with respect to one another;
a movable pill dispensing layer positioned between the first and second layers wherein a first axis extends vertically through the first layer, second layer, and pill dispensing layer and wherein a second axis extends perpendicular to said first axis through pill dispensing layer;
said pill dispensing layer comprising a holding chamber, wherein said pill dispensing layer during an ordinary dispensing operation by a user is movable along said second axis from a first loading position in which the holding chamber is aligned with the entry passage and is offset from the exit passage to receive a pill, to a second dispensing position in which the holding chamber is aligned with the exit passage and is offset from the entry passage to dispense the pill through the exit passage; and
wherein said movement from said first loading position to said second dispensing position is linear.

25. The pill dispensing assembly of claim 24, wherein the pill dispensing layer is defined by a transport shuttle comprising said holding chamber that is movable within the pill dispensing assembly between the loading and dispensing positions along said second axis.

26. The pill dispensing assembly of claim 25, wherein the transport shuttle is biased towards one of the dispensing position or the loading position by a bias member within the pill dispensing assembly.

27. The pill dispensing assembly of claim 24, further comprising at least one sensor configured to sense alignment of said holding chamber with said exit passage.

28. The pill dispensing assembly of claim 24, further comprising at least one sensor configured to sense the presence of a pill inside the holding chamber.
